(19) United States
(12) Patent Application Publication
(10) Pub. No.: US 2025/0298968 A1
(43) Pub. Date: Sep. 25, 2025

(54) DATA PROCESSING METHOD FOR SPREADSHEET, MEDIUM, ELECTRONIC DEVICE AND PROGRAM PRODUCT

(71) Applicant: Beijing Zitiao Network Technology Co., Ltd., Beijing (CN)

(72) Inventors: Li XU, Beijing (CN); Yi Fang, Beijing (CN); Jiaxiang Ye, Beijing (CN); Zhenjia Wang, Beijing (CN)

(21) Appl. No.: 19/084,661

(22) Filed: Mar. 19, 2025

(30) Foreign Application Priority Data
Mar. 20, 2024 (CN) 202410324465.6

(51) Int. Cl. G06F 40/18; G06F 16/23

(52) U.S. Cl. CPC G06F 40/18; G06F 16/2379

(57) ABSTRACT

The present disclosure relates to a data processing method for a spreadsheet, a medium, an electronic device and a program product, which relate to the field of computer technology. In the method, a first data amount of target table data for which a data change occurs in a spreadsheet is determined, and the target table data is sent to a client according to a data sending mode corresponding to the first data amount of the target table data, so that the client performs data update on the spreadsheet according to the target table data. In this way, the target table data can be sent to the client in different scenarios using different data sending modes, so as to ensure the reliable transmission of the table data between a server and the client, thereby ensuring the timeliness and integrity of the table data.

### CROSS-REFERENCE TO RELATED APPLICATION

The present application claims priority of the Chinese Patent Application No. 202410324465.6, filed on Mar. 20, 2024, the disclosure of which is incorporated herein by reference in its entirety as part of the present application.

### TECHNICAL FIELD

The present disclosure relates to the field of computer technology, and in particular, to a data processing method for a spreadsheet, a medium, an electronic device and a program product.

### BACKGROUND

Data of an online spreadsheet can be distributed by a server to a client, so as to ensure that users see the same content. However, with the increase of the data amount of the online spreadsheet, it may result in the server being unable to transmit data to the client in a timely and complete manner, which leads to an excessively high delay in data update of the online spreadsheet, and reduces the timeliness of the data update of the online spreadsheet.

### SUMMARY

The summary section is provided to introduce concepts in a simplified form that are described in detail in the following detailed description section. The summary section is not intended to identify key features or essential features of the claimed technical solution, nor is it intended to be used to limit the scope of the claimed technical solution.

The present disclosure provides a data processing method for a spreadsheet, which is executed by a server, and the method includes:
in response to a change in data of a spreadsheet, determining a first data amount of target table data for which a data change occurs in the spreadsheet; and
sending the target table data to a client according to a data sending mode corresponding to the first data amount of the target table data, where the target table data is used to cause the client to perform data update on the spreadsheet according to the target table data.

The present disclosure provides a data processing method for a spreadsheet, which is executed by a client, the method includes:
receiving target table data sent by a server, where the target table data is table data for which a data change occurs in a spreadsheet, and the target table data is sent by the server to the client according to a data sending mode corresponding to a first data amount of the target table data in response to a change in data of the spreadsheet; and
performing data update on the spreadsheet according to the target table data.

The present disclosure provides a computer-readable medium having a computer program stored thereon. When the program is executed by a processor, the processor implements the steps of the method mentioned above.

The present disclosure provides an electronic device, which includes a memory and a processor.

The memory stores a computer program.

The processor is configured to execute the computer program in the memory to implement the steps of the method according to the first aspect, or implement the steps of the method according to the second aspect.

The present disclosure provides a computer program product including a computer program. When the computer program is executed by a processor, the processor implements the steps of the method mentioned above.

### BRIEF DESCRIPTION OF DRAWINGS

The above and other features, advantages and aspects of the various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale. In the drawings:

FIG. 1 is a structural diagram of a data processing system for spreadsheets according to an exemplary embodiment;

FIG. 2 is a flowchart of a data processing method for a spreadsheet according to an exemplary embodiment;

FIG. 3 is a flowchart of a data processing method for a spreadsheet according to yet another exemplary embodiment;

FIG. 4 is a flowchart of a data processing method for a spreadsheet according to another exemplary embodiment;

FIG. 5 is a detailed flowchart of the step 220 shown in FIG. 1;

FIG. 6 is a flowchart of a data processing method for a spreadsheet according to an exemplary embodiment;

FIG. 7 is a schematic diagram of module connection of a data processing apparatus for spreadsheets according to an exemplary embodiment;

FIG. 8 is a schematic diagram of module connection of a data processing apparatus for spreadsheets according to an exemplary embodiment; and

FIG. 9 is a structural diagram of an electronic device according to an exemplary embodiment.

### DETAILED DESCRIPTION

The embodiments of the present disclosure will be described in more detail below with reference to the drawings. While certain embodiments of the present disclosure are shown in the drawings, it should be understood that the present disclosure may be implemented in various forms and should not be construed as limited to the embodiments set forth herein. Rather, these embodiments are provided for a thorough and complete understanding of the present disclosure. It should be understood that the drawings and the embodiments of the present disclosure are only for illustrative purposes, and are not intended to limit the scope of the present disclosure.

It should be understood that the various steps described in the method implementations of the present disclosure may be performed in different orders and/or in parallel. Furthermore, the method implementations may include additional steps and/or omit performing the illustrated steps. The scope of the present disclosure is not limited in this respect.

As used herein, the term “include” and its variants are open-ended inclusions, that is, “include but not limited to”. The term “based on” is “based at least in part on”. The term “one embodiment” means “at least one embodiment”; the term “another embodiment” means “at least one other embodiment”; and the term “some embodiments” means “at least some embodiments”. Relevant definitions of other terms will be given in the description below.

It should be noted that concepts such as “first” and “second” mentioned in the present disclosure are only used to distinguish different apparatuses, modules or units, and are not used to limit the order of functions performed by these apparatuses, modules or units or their interdependence.

It should be noted that the modifications of “one” and “a plurality of” mentioned in the present disclosure are illustrative rather than restrictive, and those skilled in the art should understand that unless clearly indicated in the context, they should be understood as “one or more”.

The names of messages or information exchanged between a plurality of apparatuses in the implementations of the present disclosure are only for illustrative purposes, and are not intended to limit the scope of these messages or information.

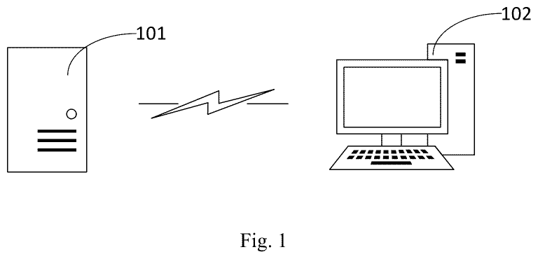

FIG. 1 is a structural diagram of a data processing system for spreadsheets according to an exemplary embodiment. As shown in FIG. 1, the data processing system includes a server 101 and a client 102, where the server 101 and the client 102 may exchange data through wired connection or wireless connection.

The server 101 is configured to determine, in response to a change in data of a spreadsheet, the first data amount of target table data for which a data change occurs in the spreadsheet, and the server 101 is configured to send the target table data to the client 102 according to a data sending mode corresponding to the first data amount of the target table data. The client 102 is configured to receive the target table data sent by the server 101, and perform data update on the spreadsheet according to the target table data.

Based on this, the server 101 may use different data sending modes to send the target table data to the client 102 according to different first data amounts, thereby ensuring the timeliness and integrity of sending the target table data to the client 102 in different scenarios.

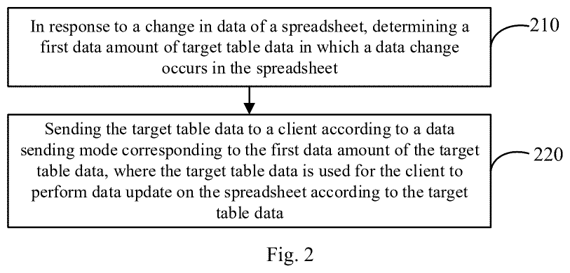

FIG. 2 is a flowchart of a data processing method for a spreadsheet according to an exemplary embodiment. As shown in FIG. 2, an embodiment of the present disclosure provides a data processing method for a spreadsheet, which is executed by the server shown in FIG. 1, and the data processing method for a spreadsheet may include the following steps.

In step 210, in response to a change in data of a spreadsheet, determining a first data amount of target table data for which a data change occurs in the spreadsheet.

Here, the data change occurs in the data of the spreadsheet, which may be caused by a user editing table data on a server through a client and results in a change in data of the spreadsheet. In the case where the data of the spreadsheet changes, the server can determine the first data amount of the target table data for which the data change occurs in the spreadsheet.

The target table data for which the data change occurs in the spreadsheet may refer to cells for which the data change occurs, that is, the target table data is data corresponding to all cells for which the data change occurs, and data of cells without the data change may not be included in the target table data. The first data amount refers to a size of the target table data, which reflects a size of space occupied by the target table data.

In an online spreadsheet, some data may be made invisible to some users through some authority settings. In response to the invisible part of data is referenced in formula calculation, it will lead to inconsistency in calculation results seen by users with different authority, thereby leading to impact on correct transmission of information and reducing work efficiency. In the face of this scenario, calculation results may be distributed to the client through the data processing method for a spreadsheet proposed in the embodiments of the present disclosure. That is, the server is responsible for using all data to perform formula calculation, and then the server sends a corresponding calculation result to each client, thereby avoiding the problem of inconsistency in data seen by different users.

It should be noted that, in the scenario of formula calculation, the above target table data may refer to the above formula calculation result.

Of course, the data processing method for a spreadsheet proposed in the embodiments of the present disclosure is not limited to transmitting the formula calculation result to the client, and other data for which a change occurs may also be transmitted. That is, the data processing method for a spreadsheet proposed in the embodiments of the present disclosure may be used to transmit any data to the client.

In step 220, sending the target table data to a client according to a data sending mode corresponding to the first data amount of the target table data, where the target table data is used to cause the client to perform data update on the spreadsheet according to the target table data.

Here, for target table data with different first data amounts, different data sending modes may be used to transmit the target table data to the client. For example, in response to the first data amount of the target table data being small, the server may push the target table data to the client, and in response to the first data amount of the target table data being large, the server may notify the client to pull the target table data from the server.

It should be understood that, in the process of pushing the target table data from the server to the client, the server (the data sender) actively sends the target table data to the client (the data receiver). By the mode of pushing, the real-time performance of data is strong, and the server may immediately notify the client when data is updated, and the target table data may be transmitted without the client's request, but the mode of pushing will be limited by the push bandwidth. In the process of pulling the target table data from the server by the client, the client actively initiates a request and acquire the target table data from the server. In response to the request initiated by the client, the server returns the target table data to the client. The mode of pulling may be scheduled according to requirements, which is more flexible.

It is worth noting that after receiving the target table data, the client performs data update on the table area corresponding to the spreadsheet based on the target table data, so as to display the target table data.

Therefore, by determining the first data amount of the target table data for which a data change occurs in the spreadsheet, and sending the target table data to the client according to the data sending mode corresponding to the first data amount of the target table data, so that the client performs data update on the spreadsheet according to the target table data, the target table data can be sent to the client in different scenarios using different data sending modes, so as to ensure the reliable transmission of the table data between the server and the client, thereby ensuring the timeliness and integrity of the table data.

In some possible implementations, in the step 220, the server may send the target table data to the client according to a data sending mode corresponding to the first data amount and a push bandwidth of the server.

Here, the push bandwidth refers to network bandwidth resources required for the server to actively push data to the client in a network communication process, and the push bandwidth may be a maximum rate at which the server sends data to the client per unit time. The server needs to have sufficient push bandwidth to ensure that data is delivered to each client in a timely and effective manner, without causing a delay in data transmission or a decline in service quality due to insufficient push bandwidth.

In the embodiment of the present disclosure, a data sending mode for transmitting the target table data to the client may be selected according to the first data amount and the push bandwidth of the server, so as to transmit the target table data to the client through the data sending mode.

In some embodiments, the target table data is pushed to the client when the first data amount is less than or equal to the push bandwidth.

The first data amount of the target table data being less than or equal to the push bandwidth of the server means that the push bandwidth of the server may support the server to directly push the target table to the client, and the server uses the data sending mode of pushing to push the target table data to the client, so as to ensure the real-time performance of the update of the table data.

In some other embodiments, when the first data amount is greater than the push bandwidth, the server may determine a second data amount of area information that is used for describing a table area corresponding to the target table data, and when the second data amount is less than or equal to the push bandwidth, the area information is pushed to the client.

The first data amount of the target table data being greater than the push bandwidth of the server means that the push bandwidth of the server is insufficient to support the server to push the target table to the client. The table area corresponding to the target table data may refer to a specific position where a data change occurs in the spreadsheet, such as a specific cell, a row, a column, and so on. The area information that is used for describing the table area corresponding to the target table data may refer to information for describing the table area. For example, in response to the table area being a cell in the Nth row and the Mth column, then the area information may be a cell in the Nth row and the Mth column. Of course, in a practical application process, the area information may also be represented by other agreed characters.

The second data amount of the area information being less than or equal to the push bandwidth of the server means that the push bandwidth of the server may support the server to push the area information to the client. In this case, the server may directly push the area information to the client. The area information is used to cause the client to pull the target table data corresponding to the area information from the server according to the area information.

That is, when the first data amount is greater than the push bandwidth, in response to the second data amount of the area information being less than or equal to the push bandwidth, the server pushes the area information to the client. After receiving the area information, the client pulls the target table data corresponding to the area information from the server.

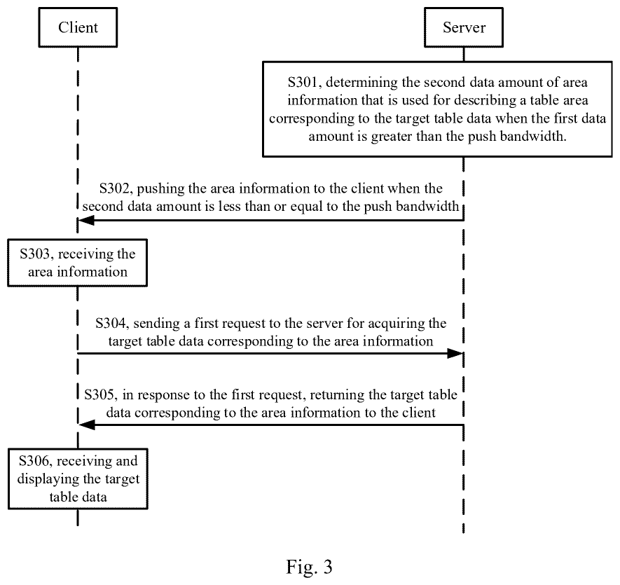

FIG. 3 is a flowchart of a data processing method for a spreadsheet according to yet another exemplary embodiment. As shown in FIG. 3, the target table data may be sent to the client through the following steps.
S301: determining, by the server, the second data amount of area information that is used for describing a table area corresponding to the target table data when the first data amount is greater than the push bandwidth.
S302: pushing, by the server, the area information to the client when the second data amount is less than or equal to the push bandwidth.
S303: receiving the area information by the client.
S304: sending, by the client, a first request to the server for acquiring the target table data corresponding to the area information.
S305: in response to the first request, returning, by the server, the target table data corresponding to the area information to the client.
S306: receiving and displaying the target table data by the client.

In yet some other embodiments, a preset message is sent to the client when the second data amount is greater than the push bandwidth.

The preset message is used to cause the client to pull area information corresponding to the preset message from the server in response to the preset message, and pull target table data corresponding to the area information from the server according to the area information.

It should be noted that the preset message may be understood as a signal, and the preset message is used to notify the client that the data amount of the target table data or the area information is too large, and the server cannot directly push the target table data or the area information to the client. It should be understood that the preset message may be used to indicate the client to pull the corresponding area information from the server.

In response to the preset message, the client may pull the area information corresponding to the preset message from the server, and pull the target table data corresponding to the area information from the server according to the area information.

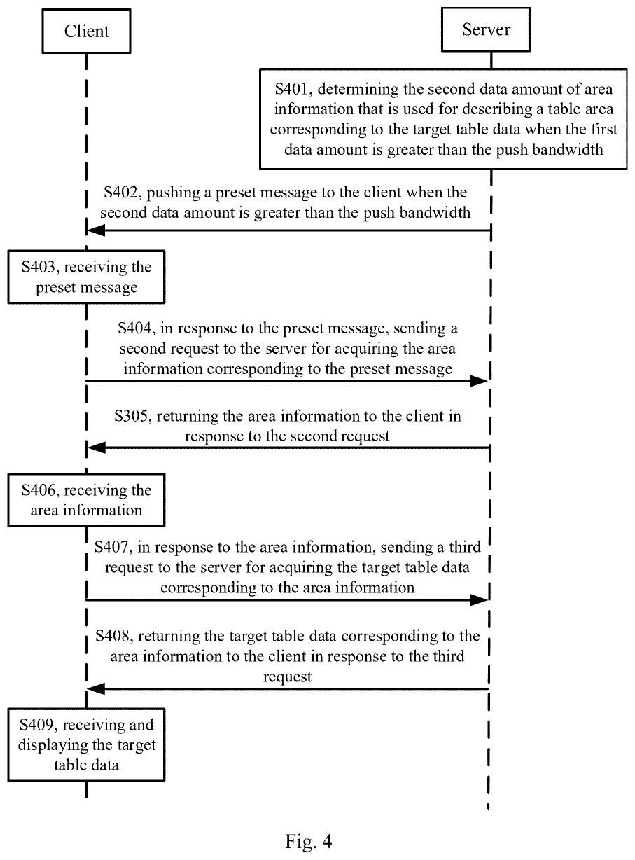

FIG. 4 is a flowchart of a data processing method for a spreadsheet according to another exemplary embodiment. As shown in FIG. 4, the target table data may be sent to the client through the following steps.
S401: determining, by the server, the second data amount of area information that is used for describing a table area corresponding to the target table data when the first data amount is greater than the push bandwidth.
S402: pushing, by the server, a preset message to the client when the second data amount is greater than the push bandwidth.
S403: receiving the preset message by the client.
S404: in response to the preset message, sending, by the client, a second request to the server for acquiring the area information corresponding to the preset message.
S405: returning, by the server, the area information to the client in response to the second request.
S406: receiving the area information by the client.
S407: in response to the area information, sending, by the client, a third request to the server for acquiring the target table data corresponding to the area information.
S408: returning, by the server, the target table data corresponding to the area information to the client in response to the third request.
S409: receiving and displaying the target table data by the client.

Therefore, by determining the data sending mode according to the first data amount and the push bandwidth of the server, the target table data may be transmitted to the client by using different data sending modes in different scenarios, so as to ensure the reliable transmission of the table data between the server and the client, thereby ensuring the timeliness and integrity of the table data.

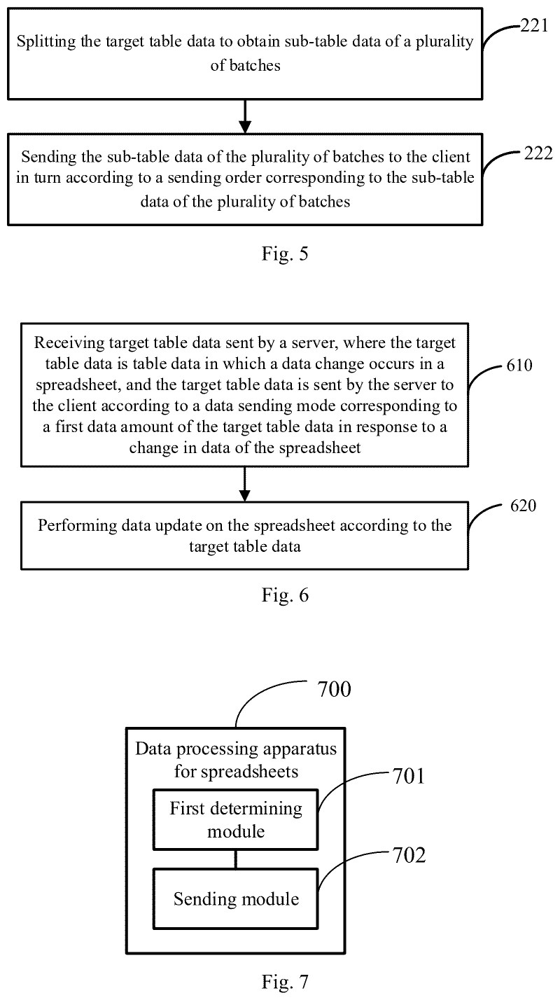

FIG. 5 is a detailed flowchart of the step 220 shown in FIG. 1. As shown in FIG. 5, the step 220 may include the following steps.

In the step 221, splitting the target table data to obtain sub-table data of a plurality of batches.

Here, the server may evenly or unevenly split the target table data into sub-table data of the plurality of batches. For example, the target table data includes data of 1,000 cells, then the data of 1,000 cells may be split into sub-table data of 100 batches, and the sub-table data of each batch includes table data of 10 cells.

In some embodiments, an operation area of a spreadsheet displayed by a user on the client may be determined, and the target table data may be split according to the operation area to obtain the sub-table data of the plurality of batches.

The operation area of the spreadsheet displayed by the user on the client may refer to a table area that the user is currently operating on the spreadsheet displayed on the client. Splitting the target table data according to the operation area may be: dividing cells adjacent to the operation area into a first area, then taking the first area as a starting point, and successively taking a plurality of cells adjacent to the first area as a second area, and so on, to obtain a plurality of areas, where table data corresponding to each area is taken as sub-table data of a batch.

It should be understood that, by splitting the target table data through the operation area to obtain table data of a plurality of batches, cells that the user is operating may be divided into the first batch, and the server may preferentially send the sub-table data corresponding to the table area that the user is operating to the client, so as to preferentially display the sub-table data corresponding to the table area that the user is operating.

In the step 222, sending sequentially the sub-table data of the plurality of batches to the client according to a sending order corresponding to the sub-table data of the plurality of batches.

Here, the server may sequentially send the sub-table data of the plurality of batches to the client according to the sending order corresponding to the sub-table data of the plurality of batches. For example, assuming that the target table data is divided into sub-table data of 5 batches, the sub-table data of the first batch is first sent to the client, and then the sub-table data of the second batch, the third batch, the fourth batch and the fifth batch is sent.

It should be understood that, in the case of splitting the target table according to the operation area, the sending order corresponding to the sub-table data of the plurality of batches is related to a distance between the sub-table data of each batch and the operation area. The shorter the distance, the earlier the batch, and accordingly, the earlier the server sends the corresponding sub-table data to the client.

It is worth noting that the server may send the sub-table data to the client through the data sending mode proposed in the above implementations. For example, the sub-table data is pushed to the client when the data amount corresponding to the sub-table data is less than or equal to the push bandwidth. When the data amount corresponding to the sub-table data is greater than the push bandwidth, in response to a data amount of the area information corresponding to the sub-table data being less than or equal to the push bandwidth, the area information corresponding to the sub-table data is pushed to the client. When the data amount corresponding to the sub-table data is greater than the push bandwidth, in response to the data amount of the area information corresponding to the sub-table data being greater than the push bandwidth, the preset message is sent to the client.

In addition, it needs to noted that each time the client acquires sub-table data of a batch, data update is performed on the spreadsheet according to the sub-table data, so as to display the sub-table data.

Therefore, by transmitting the table data to the client in batches, the speed of data update of the spreadsheet can be improved, so as to quickly display the updated data.

In some possible implementations, the sub-table data includes description information for describing whether the sub-table data is sub-table data of the last batch. The description information is used for notifying the client that sending of sub-table data of all batches has been completed, so that the client determines whether the target table data has been completely updated according to the description information.

Here, the sub-table data may carry the description information to notify the client whether the server has completed the sending of sub-table data of all batches of a version. For example, the format of sub-table data of the last batch may be “data content-batch number-data of the last batch of XX version”.

It is worth noting that by carrying the description information in the sub-table data, after acquiring the sub-table data of the last batch, the life cycle of this data update is completed, and it is determined that the target table data has been completely updated and displayed, and no further request is made to the server for acquiring the sub-table data. In response to no description information indicating that the sub-table data is the sub-table data of the last batch being carried in the sub-table data, it means that the target table data of a version has not been completely displayed.

It should be understood that, in a scenario where the formula calculation result is transmitted to the client, the server may send the formula calculation result of a batch to the client every time the server obtains the formula calculation result of the batch.

Therefore, by carrying the description information in the sub-table data, the client can be notified whether sub-table data of all batches have been completely transmitted, so that the client can determine whether the data update is completed according to the description information.

In some possible implementations, the sub-table data includes a batch number corresponding to the sub-table data and a previous batch number corresponding to the batch number, and the previous batch number is used to cause the client to, when the client does not store sub-table data corresponding to the previous batch number locally, acquire sub-table data corresponding to a missing batch number from the server according to a batch number corresponding to sub-table data included locally.

Here, sub-table data of each batch may carry a batch number corresponding to the sub-table data and a previous batch number corresponding to the batch number. For example, assuming that the sub-table data A is sub-table data of the second batch, the sub-table data A may carry a batch number “2” indicating that the sub-table data A is data of the second batch, and a batch number “1” indicating the sub-table data of the previous batch.

When receiving sub-table data of each batch, the client detects whether the client locally stores the sub-table data corresponding to the previous batch number, and in response to the client does not locally store the sub-table data corresponding to the previous batch number, the client acquires the sub-table data corresponding to the missing batch number from the server according to the batch number corresponding to the sub-table data included locally.

According to the largest batch number corresponding to the sub-table data stored locally, the client may acquire, from the server, the sub-table data of all batches after the largest batch number.

For example, when receiving sub-table data of the first batch, the client stores the sub-table data of the first batch locally. Then, the client acquires sub-table data of the second batch, and when receiving the sub-table data of the second batch, the client detects whether the sub-table data of the first batch is present locally, and in response to the sub-table data of the first batch being present, the client stores the sub-table data of the second batch locally. Next, the client acquires sub-table data of the third batch, and when acquiring the sub-table data of the third batch, the client detects whether the sub-table data of the second batch is stored locally, and in response to no sub-table data of the second batch being stored locally, the client does not store the sub-table data of the third batch, and sends the largest batch number corresponding to the sub-table data stored locally to the server, so as to acquire, through the largest batch number, the sub-table data of all batches after the largest batch number from the server.

Therefore, by carrying the batch number corresponding to the sub-table data and the previous batch number corresponding to the batch number in sub-table data of each batch, the client can perceive whether there is sub-table data of the missing batch. In the case where the transmission of sub-table data of a certain batch is missing between the server and the client due to network and other problems, the client can timely perceive the existence of the missing sub-table data, and acquire the sub-table data of the missing batch from the server, so as to ensure that the updated table data can be completely displayed in the client.

FIG. 6 is a flowchart of a data processing method for a spreadsheet according to an exemplary embodiment. As shown in FIG. 6, an embodiment of the present disclosure provides a data processing method for a spreadsheet, which is executed by the client shown in FIG. 1, and the data processing method for a spreadsheet may include the following steps.

In the step 610, receiving target table data sent by a server, where the target table data is table data for which a data change occurs in a spreadsheet, and the target table data is sent by the server to the client according to a data sending mode corresponding to a first data amount of the target table data in response to a change in data of the spreadsheet.

In the step 620, performing data update on the spreadsheet according to the target table data.

Here, for the detailed description of the above the steps 610 to 620, reference may be made to the relevant description of the embodiments on the server side, which will not be repeated here.

Therefore, through the above steps 610 to 620, the client can receive the target table data sent by the server in different scenarios by using different data sending modes, so as to ensure the reliable transmission of the table data between the server and the client, thereby ensuring the timeliness and integrity of the table data.

In some possible implementations, in the step 610, the target table data sent by the server according to a data sending mode corresponding to the first data amount and a push bandwidth corresponding to the server may be received.

In some embodiments, the target table data pushed by the server to the client is received when the first data amount is less than or equal to the push bandwidth.

In some embodiments, when the first data amount is greater than the push bandwidth, in response to the second data amount of the area information that is used for describing a table area corresponding to the target table data being less than or equal to the push bandwidth, area information pushed by the server to the client is received, and the target table data corresponding to the area information is pulled from the server according to the area information.

In some embodiments, a preset message pushed by the server to the client is received in response to the second data amount being greater than the push bandwidth, area information corresponding to the preset message is pulled from the server in response to the preset message, and the target table data corresponding to the area information is pulled from the server according to the area information.

It should be understood that for the detailed description of the above embodiments, reference may be made to the relevant description of the embodiments on the server side, which will not be repeated here.

Therefore, by determining the data sending mode according to the first data amount and the push bandwidth of the server, the target table data may be transmitted to the client by using different data sending modes in different scenarios, so as to ensure the reliable transmission of the table data between the server and the client, thereby ensuring the timeliness and integrity of the table data.

In some possible implementations, in the step 610, the client may receive the sub-table data of a plurality of batches sent by the server, where the sub-table data of the plurality of batches is obtained by the server by splitting the target table data, and the sub-table data of the plurality of batches is sequentially sent to the client according to a sending order corresponding to the sub-table data of the plurality of batches. Correspondingly, in the step 620, the client performs, for sub-table data received of each batch, data update on the spreadsheet according to the sub-table data.

It should be understood that for the detailed description of the above embodiments, reference may be made to the relevant description of the embodiments on the server side, which will not be repeated here.

Therefore, by receiving the table data in batches, the speed of data update of the spreadsheet can be improved, so as to quickly display the updated data.

In some possible implementations, the sub-table data includes description information for describing whether the sub-table data is sub-table data of a last batch. Correspondingly, it is determined that the target table data has been completely updated when the sub-table data received includes description information indicating that the sub-table data is the sub-table data of the last batch.

Here, for the detailed description of the above description information, reference may be made to the relevant description of the embodiments on the server side, which will not be repeated here.

Therefore, by carrying the description information in the sub-table data, the client can perceive whether sub-table data of all batches have been completely transmitted, so as to determine whether the data update is completed according to the description information.

In some possible implementations, the sub-table data includes a batch number corresponding to the sub-table data and a previous batch number corresponding to the batch number. Correspondingly, in the case where the client does not store the sub-table data corresponding to the previous batch number locally, the sub-table data corresponding to the missing batch number is acquired from the server according to the batch number corresponding to the sub-table data included locally.

Here, for the detailed description of the above batch numbers, reference may be made to the relevant description of the embodiments on the server side, which will not be repeated here.

Therefore, the client can timely perceive the existence of the missing sub-table data, and acquire the sub-table data of the missing batch from the server, so as to ensure that the updated table data can be completely displayed in the client.

FIG. 7 is a schematic diagram of module connection of a data processing apparatus for spreadsheets according to an exemplary embodiment. As shown in FIG. 7, an embodiment of the present disclosure provides a data processing apparatus 700 for spreadsheets, the data processing apparatus 700 is set on a server, and the data processing apparatus 700 includes a first determining module 701 and a sending module 702.

The first determining module 701 is configured to, in response to a change in data of a spreadsheet, determine a first data amount of target table data for which a data change occurs in the spreadsheet.

The sending module 702 is configured to send the target table data to a client according to a data sending mode corresponding to the first data amount of the target table data, where the target table data is used to cause the client to perform data update on the spreadsheet according to the target table data.

Optionally, the sending module 702 is specifically configured to:
send the target table data to the client according to a data sending mode corresponding to the first data amount and a push bandwidth of the server.

Optionally, the sending module 702 is specifically configured to:
push the target table data to the client when the first data amount is less than or equal to the push bandwidth;
determine a second data amount of area information that is used for describing a table area corresponding to the target table data when the first data amount is greater than the push bandwidth;
push the area information to the client when the second data amount is less than or equal to the push bandwidth, where the area information is used to cause the client to pull target table data corresponding to the area information from the server according to the area information; and
send a preset message to the client when the second data amount is greater than the push bandwidth, where the preset message is used to cause the client to pull area information corresponding to the preset message from the server in response to the preset message, and pull target table data corresponding to the area information from the server according to the area information.

Optionally, the sending module 702 includes a splitting unit and a sending unit.

The splitting unit is configured to split the target table data to obtain sub-table data of a plurality of batches.

The sending unit is configured to sequentially send the sub-table data to the client according to a sending order corresponding to the sub-table data of the plurality of batches.

Optionally, the splitting unit is specifically configured to:
determine an operation area of a spreadsheet displayed by a user on the client; and
split the target table data according to the operation area to obtain the sub-table data of the plurality of batches.

Optionally, the sub-table data includes description information for describing whether the sub-table data is sub-table data of a last batch, and the description information is used for notifying the client that sending of sub-table data of all batches has been completed, so that the client determines whether the target table data has been completely updated according to the description information.

Optionally, the sub-table data includes a batch number corresponding to the sub-table data and a previous batch number corresponding to the batch number, and the previous batch number is used to cause the client to, when the client does not store sub-table data corresponding to the previous batch number locally, acquire the sub-table data corresponding to a missing batch number from the server according to a batch number corresponding to sub-table data included locally.

For the logic of the methods performed by the various functional modules in the above data processing apparatus 700 for spreadsheets, reference may be made to the method parts related to the above embodiments, which will not be repeated here.

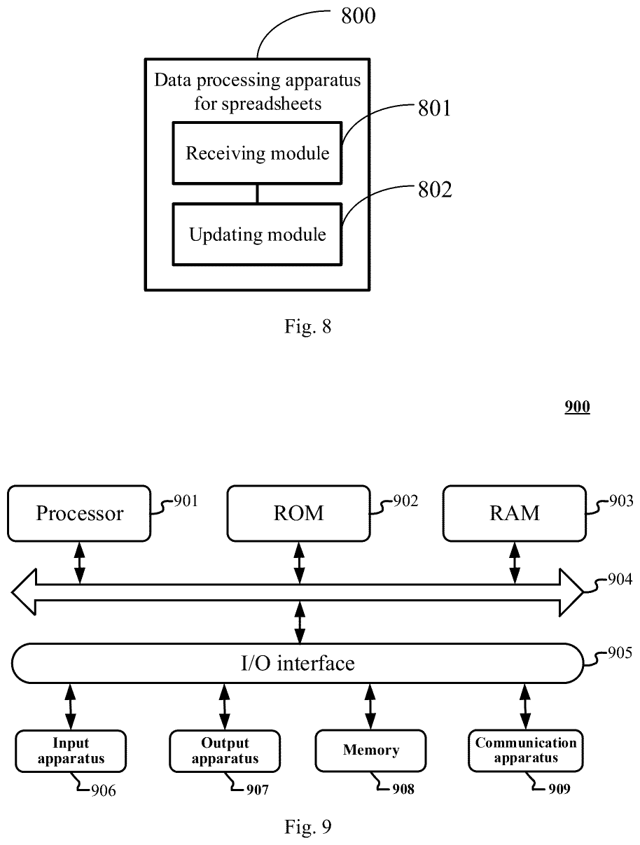

FIG. 8 is a schematic diagram of module connection of a data processing apparatus for spreadsheets according to an exemplary embodiment. As shown in FIG. 8, an embodiment of the present disclosure provides a data processing apparatus 800 for spreadsheets, the data processing apparatus 800 is set on a client, and the data processing apparatus 800 includes a receiving module 801 and an updating module 802.

The receiving module 801 is configured to receive target table data sent by a server, where the target table data is table data for which a data change occurs in a spreadsheet, and the target table data is sent by the server to the client according to a data sending mode corresponding to a first data amount of the target table data in response to a change in data of the spreadsheet.

The updating module 802 is configured to perform data update on the spreadsheet according to the target table data.

Optionally, the receiving module 801 is specifically configured to:
receive the target table data sent by the server according to a data sending mode corresponding to the first data amount and a push bandwidth corresponding to the server.

Optionally, the receiving module 801 is specifically configured to:
receive the target table data pushed by the server to the client when the first data amount is less than or equal to the push bandwidth;
when the first data amount is greater than the push bandwidth, in response to the second data amount of the area information that is used for describing a table area corresponding to the target table data being less than or equal to the push bandwidth, receive the area information pushed by the server to the client;
pull target table data corresponding to the area information from the server according to the area information;
receive the preset message pushed by the server to the client in response to the second data amount being greater than the push bandwidth;
pull area information corresponding to the preset message from the server in response to the preset message; and
pull target table data corresponding to the area information from the server according to the area information.

Optionally, the receiving module 801 is specifically configured to:
receive the sub-table data of a plurality of batches sent by the server, where the sub-table data of the plurality of batches is obtained by the server by splitting the target table data, and is sequentially sent to the client according to a sending order corresponding to the sub-table data of the plurality of batches.

The updating module 802 is specifically configured to:
perform, for sub-table data received of each batch, data update on the spreadsheet according to the sub-table data.

Optionally, the sub-table data includes description information for describing whether the sub-table data is sub-table data of a last batch; and the data processing apparatus 800 further includes a second determining module.

The second determining module is configured to determine that the target table data has been completely updated when the sub-table data received includes description information indicating that the sub-table data is the sub-table data of the last batch.

Optionally, the sub-table data includes a batch number corresponding to the sub-table data and a previous batch number corresponding to the batch number, and the data processing apparatus 800 further includes an acquiring module.

The acquiring module is configured to acquire, when the client does not store sub-table data corresponding to the previous batch number locally, the sub-table data corresponding to a missing batch number from the server according to a batch number corresponding to sub-table data included locally.

For the logic of the methods performed by the various functional modules in the above data processing apparatus 800 for spreadsheets, reference may be made to the method parts related to the above embodiments, which will not be repeated here.

Reference is made to FIG. 9 below, which illustrates a structural diagram of an electronic device 900 (such as the client or the server in FIG. 1) suitable for implementing the embodiments of the present disclosure. The client in the embodiment of the present disclosure may include, but is not limited to, mobile terminals such as a mobile phone, a laptop, a digital broadcast receiver, a PDA (Personal Digital Assistant), a tablet computer, a PMP (Portable Multimedia Player), a vehicle-mounted terminal (such as a vehicle-mounted navigation terminal), etc., and fixed terminals such as a digital TV, a desktop computer, etc. The electronic device shown in FIG. 9 is only an example, and should not bring any limitation to the functions and usage scopes of the embodiments of the present disclosure.

As shown in FIG. 9, the electronic device 900 may include a processor (such as a central processing unit, a graphics processing unit, etc.) 901 that may perform various appropriate actions and processes according to a program stored in a read-only memory (ROM) 902 or a program loaded from a memory 908 into a random access memory (RAM) 903. The RAM 903 also stores various programs and data required for the operation of the electronic device 900. The processor 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, a gyroscope, etc.; an output apparatus 907 including, for example, a liquid crystal display (LCD), a loudspeaker, a vibrator, etc.; a memory 908 including, for example, a magnetic tape, a hard disk, etc.; and a communication apparatus 909. The communication apparatus 909 may allow the electronic device 900 to perform wireless or wired communication with other devices to exchange data. While FIG. 9 illustrates the electronic device 900 having various apparatuses, it should be understood that not all of the illustrated apparatuses are required to be implemented or present. More or fewer apparatuses may be implemented or present alternatively.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, and the computer program includes program code for executing the method shown in the flowchart. In such an embodiment, the computer program may be downloaded from a network and installed through the communication apparatus 909, or installed from the memory 908, or installed from the ROM 902. When the computer program is executed by the processor 901, the above functions defined in the methods of the embodiments of the present disclosure are performed.

It should be noted that the above computer-readable medium in the present disclosure may be a computer-readable signal medium or a computer-readable storage medium, or any combination of the above two. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, however, the computer-readable signal medium may include a data signal propagated in a baseband or as a part of a carrier wave, in which computer-readable program code is carried. This propagated data signal may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including but not limited to: wire, optical cable, RF (radio frequency), etc., or any suitable combination of the above.

In some implementations, the client and the server may use any currently known or future-developed network protocol, such as HTTP (HyperText Transfer Protocol), to perform communication, and may communicate (via a communication network) and interconnect with digital data in any form or medium. Examples of the communication network include a local area network (“LAN”), a wide area network (“WAN”), an internet (for example, the Internet), and an end-to-end network (for example, an ad hoc end-to-end network), as well as any currently known or future-developed network.

The above computer-readable medium may be included in the above electronic device; or may exist alone without being assembled into the electronic device.

The above computer-readable medium carries one or more programs, and when the one or more programs are executed by the electronic device, the electronic device is caused to: in response to a change in data of a spreadsheet, determine a first data amount of target table data for which a data change occurs in the spreadsheet; and send the target table data to a client according to a data sending mode corresponding to the first data amount of the target table data, where the target table data is used to cause the client to perform data update on the spreadsheet according to the target table data.

Alternatively, the above computer-readable medium carries one or more programs, and when the one or more programs are executed by the electronic device, the electronic device is caused to: receive target table data sent by a server, where the target table data is table data for which a data change occurs in a spreadsheet, and the target table data is sent by the server to the client according to a data sending mode corresponding to a first data amount of the target table data in response to a change in data of the spreadsheet; and perform data update on the spreadsheet according to the target table data.

Computer program codes for carrying out operations of the present disclosure may be written in one or more programming languages or any combination thereof, including an object oriented programming language such as Java, Smalltalk, C++ and a conventional procedural programming language such as C programming language or similar programming languages. The program codes may be executed entirely on a user computer, partly on a user computer, as a stand-alone software package, partly on a user computer and partly on a remote computer, or entirely on a remote computer or a server. In the case of the remote computer, the remote computer may be connected to the user computer through any kind of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may occur out of the order noted in the drawings. For example, two blocks shown in succession may, in fact, can be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or in hardware. The name of a module does not constitute a limitation on the module itself under certain circumstances.

The functions described herein above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, but also covers other technical solutions formed by any combination of the above technical features or their equivalent features without departing from the above disclosed concept, for example, a technical solution formed by replacing the above features with technical features with similar functions disclosed in the present disclosure (but not limited to).

In addition, although operations are depicted in a particular order, this should not be construed as requiring that such operations are performed in the particular order shown or performed in a sequential order. Under certain circumstances, multitasking and parallel processing may be advantageous. Similarly, although the above discussion contains several specific implementation details, these should not be construed as limiting the scope of the present disclosure. Certain features that are described in the context of separate embodiments may also be implemented in combination in a single embodiment. Conversely, various features described in the context of a single embodiment may also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims. With regard to the apparatus in the above embodiments, the specific manner in which each module performs operations has been described in detail in the embodiments relating to the method, which will not be described in detail here.

1. A data processing method for a spreadsheet, executed by a server, comprising:
in response to a change in data of a spreadsheet, determining a first data amount of target table data for which a data change occurs in the spreadsheet; and
sending the target table data to a client according to a data sending mode corresponding to the first data amount of the target table data, wherein the target table data is used to cause the client to perform data update on the spreadsheet according to the target table data.

2. The method of claim 1, wherein the sending the target table data to a client according to a data sending mode corresponding to the first data amount of the target table data, comprises:
sending the target table data to the client according to a data sending mode corresponding to the first data amount and a push bandwidth of the server.

3. The method of claim 2, wherein the sending the target table data to the client according to a data sending mode corresponding to the first data amount and a push bandwidth of the server, comprises:
pushing the target table data to the client when the first data amount is less than or equal to the push bandwidth;
determining a second data amount of area information that is used for describing a table area corresponding to the target table data when the first data amount is greater than the push bandwidth;
pushing the area information to the client when the second data amount is less than or equal to the push bandwidth, wherein the area information is used to cause the client to pull target table data corresponding to the area information from the server according to the area information; and
sending a preset message to the client when the second data amount is greater than the push bandwidth, wherein the preset message is used to cause the client to pull area information corresponding to the preset message from the server in response to the preset message, and pull target table data corresponding to the area information from the server according to the area information.

4. The method of claim 1, wherein the sending the target table data to a client, comprises:
splitting the target table data to obtain sub-table data of a plurality of batches; and
sending sequentially the sub-table data to the client according to a sending order corresponding to the sub-table data of the plurality of batches.

5. The method of claim 4, wherein the splitting the target table data to obtain sub-table data of a plurality of batches, comprises:
determining an operation area of a spreadsheet displayed by a user on the client; and
splitting the target table data according to the operation area to obtain the sub-table data of the plurality of batches.

6. The method of claim 4, wherein the sub-table data comprises description information for describing whether the sub-table data is sub-table data of a last batch, and the description information is used for notifying the client that sending of sub-table data of all batches has been completed, so that the client determines whether the target table data has been completely updated according to the description information.

7. The method of claim 4, wherein the sub-table data comprises a batch number corresponding to the sub-table data and a previous batch number corresponding to the batch number, and the previous batch number is used to cause the client to, when the client does not store sub-table data corresponding to the previous batch number locally, acquire sub-table data corresponding to a missing batch number from the server according to a batch number corresponding to sub-table data comprised locally.

8. The method of claim 3, wherein the sending the target table data to a client, comprises:
splitting the target table data to obtain sub-table data of a plurality of batches; and
sending sequentially the sub-table data to the client according to a sending order corresponding to the sub-table data of the plurality of batches.

9. A data processing method for a spreadsheet, executed by a client, comprising:
receiving target table data sent by a server, wherein the target table data is table data for which a data change occurs in a spreadsheet, and the target table data is sent by the server to the client according to a data sending mode corresponding to a first data amount of the target table data in response to a change in data of the spreadsheet; and
performing data update on the spreadsheet according to the target table data.

10. The method of claim 9, wherein the receiving target table data sent by a server, comprises:
receiving the target table data sent by the server according to a data sending mode corresponding to the first data amount and a push bandwidth corresponding to the server.

11. The method of claim 10, wherein the receiving the target table data sent by the server according to a data sending mode corresponding to the first data amount and a push bandwidth corresponding to the server comprises:
when the first data amount is less than or equal to the push bandwidth, receiving the target table data pushed by the server to the client;
when the first data amount is greater than the push bandwidth, in response to a second data amount of area information that is used for describing a table area corresponding to the target table data being less than or equal to the push bandwidth, receiving the area information pushed by the server to the client;
pulling target table data corresponding to the area information from the server according to the area information;
receiving a preset message pushed by the server to the client in response to the second data amount being greater than the push bandwidth;
pulling area information corresponding to the preset message from the server in response to the preset message; and
pulling target table data corresponding to the area information from the server according to the area information.

12. The method of claim 9, wherein the receiving target table data sent by a server, comprises:
receiving sub-table data of a plurality of batches sent by the server, wherein the sub-table data of the plurality of batches is obtained by the server by splitting the target table data, and is sequentially sent to the client according to a sending order corresponding to the sub-table data of the plurality of batches; and
the performing data update on the spreadsheet according to the target table data, comprises:
performing, for sub-table data received of each batch, data update on the spreadsheet according to the sub-table data.

13. The method of claim 12, wherein the sub-table data comprises description information for describing whether the sub-table data is sub-table data of a last batch, and the method further comprises:
determining that the target table data has been completely updated when the sub-table data received comprises description information indicating that the sub-table data is the sub-table data of the last batch.

14. The method of claim 12, wherein the sub-table data comprises a batch number corresponding to the sub-table data and a previous batch number corresponding to the batch number, and the method further comprises:
when the client does not store sub-table data corresponding to the previous batch number locally, acquiring sub-table data corresponding to a missing batch number from the server according to a batch number corresponding to sub-table data comprised locally.

15. The method of claim 8, wherein the receiving target table data sent by a server, comprises:
receiving sub-table data of a plurality of batches sent by the server, wherein the sub-table data of the plurality of batches is obtained by the server by splitting the target table data, and is sequentially sent to the client according to a sending order corresponding to the sub-table data of the plurality of batches; and
the performing data update on the spreadsheet according to the target table data, comprises:
performing, for sub-table data received of each batch, data update on the spreadsheet according to the sub-table data.

16. A non-transitory computer-readable medium, wherein a computer program is stored on the non-transitory computer-readable medium, and when the program is executed by a processor, the processor implements steps of a data processing method for a spreadsheet,
when the method is executed by a server, the method comprises:
in response to a change in data of a spreadsheet, determining a first data amount of target table data for which a data change occurs in the spreadsheet, and
sending the target table data to a client according to a data sending mode corresponding to the first data amount of the target table data, wherein the target table data is used to cause the client to perform data update on the spreadsheet according to the target table data;
when the method is executed by the client, the method comprises:
receiving the target table data sent by the server, wherein the target table data is the table data for which the data change occurs in the spreadsheet, and the target table data is sent by the server to the client according to the data sending mode corresponding to the first data amount of the target table data in response to the change in the data of the spreadsheet, and
performing data update on the spreadsheet according to the target table data.

17. The non-transitory computer-readable medium of claim 16, wherein the sending the target table data to a client according to a data sending mode corresponding to the first data amount of the target table data, comprises:
sending the target table data to the client according to a data sending mode corresponding to the first data amount and a push bandwidth of the server.

18. The non-transitory computer-readable medium of claim 17, wherein the sending the target table data to the client according to a data sending mode corresponding to the first data amount and a push bandwidth of the server, comprises:
pushing the target table data to the client when the first data amount is less than or equal to the push bandwidth;
determining a second data amount of area information that is used for describing a table area corresponding to the target table data when the first data amount is greater than the push bandwidth;
pushing the area information to the client when the second data amount is less than or equal to the push bandwidth, wherein the area information is used to cause the client to pull target table data corresponding to the area information from the server according to the area information; and
sending a preset message to the client when the second data amount is greater than the push bandwidth, wherein the preset message is used to cause the client to pull area information corresponding to the preset message from the server in response to the preset message, and pull target table data corresponding to the area information from the server according to the area information.

19. The non-transitory computer-readable medium of claim 16, wherein the sending the target table data to a client, comprises:
splitting the target table data to obtain sub-table data of a plurality of batches; and
sending sequentially the sub-table data to the client according to a sending order corresponding to the sub-table data of the plurality of batches.

20. The non-transitory computer-readable medium of claim 19, wherein the splitting the target table data to obtain sub-table data of a plurality of batches, comprises:
determining an operation area of a spreadsheet displayed by a user on the client; and
splitting the target table data according to the operation area to obtain the sub-table data of the plurality of batches.
